(19) United States
(12) Patent Application Publication
(10) Pub. No.: US 2016/0107835 A1
(43) Pub. Date: Apr. 21, 2016

(54) DUSTBIN COMPRESSING ITEMS BORNE IN INTERNAL SPACE

(71) Applicant: SHENZHEN LIANSHUO AUTOMATION TECHNOLOGY CO., LTD., Shenzhen, Guangdong Province (CN)

(72) Inventors: Ya YANG, Shenzhen, Guangdong Province (CN); Shunping YU, Shenzhen, Guangdong Province (CN); Ming ZHOU, Shenzhen, Guangdong Province (CN); Kai LI, Shenzhen, Guangdong Province (CN); Zhe DU, Shenzhen, Guangdong Province (CN); Min JIANG, Shenzhen, Guangdong Province (CN); Limei LIU, Shenzhen, Guangdong Province (CN)

(73) Assignee: SHENZHEN LIANSHUO AUTOMATION TECHNOLOGY CO., LTD., Shenzhen, Guangdong Province (CN)

(21) Appl. No.: 14/892,576

(22) PCT Filed: Apr. 24, 2014
(86) PCT No.: PCT/CN2014/076154

§ 371 Date: Nov. 20, 2015

(30) Foreign Application Priority Data
Apr. 11, 2014 (CN) 201420174357.7

(51) Int. Cl. B65F 1/14

(52) U.S. Cl. CPC B65F 1/1405

(57) ABSTRACT

The invention provides a garbage can capable of compressing items contained in an internal space thereof. The garbage can comprises a can housing, wherein axially symmetrical openings are formed in a side wall at the upper end of the can housing; door sheets in fit sizes are arranged in the openings; the upper ends of the door sheets are articulated with the can housing; a compression device is arranged on the top surface in the can housing; a control end of the compression device is connected with an output end of a controller; an input end of the controller is connected with output ends of door opening sensing devices; the door opening sensing devices are arranged on the door sheets; and the controller compresses the items contained in the can housing to release the space according to door opening times detected by the door opening sensing devices.

### TECHNICAL FIELD

The invention belongs to the field of mechanical equipment and particularly relates to a garbage can capable of compressing items, or articles, contained in an internal space of the garbage can.

### BACKGROUND

At present, a waste bin or a garbage can is a container configured to contain household garbage. As more and more garbage is produced in daily life, while the capacity of the waste bin or the garbage can is limited, the waste bin or the garbage can is fully filled quickly, and people dump the garbage frequently, thereby being time-consuming and labor-consuming. The waste bin or the garbage can configured to store the household garbage does not have a compression function. Generally, the garbage is transported to a waste transfer station for centralized compression treatment. If the garbage in the waste bin or the garbage can is not compressed, the waste bin or the garbage can will be full, much manpower is required for cleaning and replacement, talents are waste, and the transportation cost is increased.

### SUMMARY

The invention provides a garbage can capable of compressing items, or articles, contained in an internal space of the garbage can. The garbage can aims at solving the problem that the existing waste bin or garbage can cannot compress the items contained in the internal space thereof.

The invention is implemented in a way that: a garbage can capable of compressing items contained in an internal space thereof comprises a can housing, wherein axially symmetrical openings are formed in a side wall at the upper end of the can housing; door sheets in fit sizes are arranged in the openings; the upper ends of the door sheets are articulated with the can housing; a compression device is arranged on the top surface in the can housing; a control end of the compression device is connected with an output end of a controller; an input end of the controller is connected with output ends of door opening sensing devices; the door opening sensing devices are arranged on the door sheets; and the controller compresses the items contained in the can housing to release the space according to door opening times detected by the door opening sensing devices.

Further, the compression device comprises a pressure plate, a driving device, two telescopic brackets and a plurality of fixing shafts, wherein each of the two opposite ends of the pressure plate is connected with one end of each telescopic bracket via the fixing shafts; and the other ends of the two telescopic brackets are connected with the driving device.

Further, the compression device further comprises a first guide rod and a second guide rod, wherein one end of the first guide rod is connected with the second guide rod via a connecting rod shaft; the other end of the first guide rod is connected with the pressure plate via a connecting rod shaft; and the other end of the second guide rod is fixed on the driving device via a connecting rod shaft.

Further, the driving device comprises a first fixing seat, a second fixing seat, a reduction gearbox, a motor, a gear, a transmission rod, a driven rod, a sensor mounting sheet and a first sensor, wherein the gear comprises a first gear, a second gear, a third gear and a fourth gear; the first fixing seat and the second fixing seat are oppositely arranged on a top plate in the can housing; two adjacent bearings are arranged on each of the first fixing seat and the second fixing seat; the two ends of the transmission rod penetrate through one bearing arranged on the first fixing seat and one bearing arranged the second fixing seat respectively, and the two bearings are arranged symmetrically; the second gear and the third gear are arranged at the two ends of the transmission rod and fixed by gear keys respectively; a motor shaft of the motor penetrates through the other bearing on the first fixing seat via the reduction gearbox; the first gear is arranged on the motor shaft and fixed by a gear key; the first gear is engaged with the second gear; one end of the driven rod is arranged on the other bearing on the second fixing seat; the fourth gear is arranged at the other end of the driven rod and fixed by a gear key; the third gear is engaged with the fourth gear; the sensor mounting sheet is arranged on a side wall of the first fixing seat; and the first sensor is arranged on the sensor mounting sheet.

Further, the telescopic brackets comprise first fixing rods, second fixing rods, first connecting rods, second connecting rods, third connecting rods, fourth connecting rods, first rotation rods, second rotation rods, a plurality of bearings and a plurality of connecting rod shafts, wherein one bearing is arranged at each of the two ends of each of the first fixing rods, the second fixing rods, the first connecting rods, the second connecting rods, the third connecting rods, the fourth connecting rods, the first rotation rods and the second rotation rods; one bearing is arranged in the center of each of the first connecting rods, the second connecting rods, the third connecting rods and the fourth connecting rods; the centers of the first connecting rods and the second connecting rods are connected by the connecting rod shafts; the centers of the third connecting rods and the fourth connecting rods are connected by the connecting rod shafts; one end of each first fixing rod and one end of each second connecting rod are connected with the pressure plate via the connecting rod shafts; the other end of each first fixing rod is connected with one end of each first connecting rod via the connecting rod shaft; the other end of each first connecting rod is connected with one end of each fourth connecting rod via the connecting rod shaft; the other end of each fourth connecting rod is connected with one end of each first rotation rod via the connecting rod shaft; the other end of each first rotation rod is connected with the transmission rod; the other end of each second fixing rod is connected with one end of each second connecting rod via the connecting rod shaft; the other end of each second connecting rod is connected with one end of each third connecting rod via the connecting rod shaft; the other end of each third connecting rod is connected with one end of each second rotation rod via the connecting rod shaft; and the other end of each second rotation rod is connected with the motor shaft or the driven rod.

Further, the door opening sensing devices comprise connecting rod fixing blocks, second connecting shafts, articulation connecting rods, first connecting rods, articulation bearings, slide shafts, slide fixing seats, linear bearings, second sensors and door opening sensing mounting sheets, wherein the connecting rod fixing rods are arranged on the door sheets; one end of each articulation connecting rod is fixed on each connecting rod fixing block via each second connecting shaft; each articulation bearing is arranged at the other end of each articulation connecting rod; one end of each slide shaft is fixed on each articulation bearing via each first connecting shaft; the other end of each slide shaft penetrates through each linear bearing and is arranged on each slide fixing seat; one end of each door opening sensing mounting sheet is arranged on each slide fixing seat; and each second sensor is arranged at the other end of each door opening sensing mounting sheet.

The garbage can has the beneficial effects that the garbage can is simple in structure, convenient and practical; the capacity of a waste bin is increased; after garbage in the garbage can or the waste bin is compressed, the single garbage can can store more garbage at a time; frequent replacement or cleaning is not required; the labor cost and garbage transportation cost are saved; and the garbage can is economical and practical.

### BRIEF DESCRIPTION OF THE DRAWINGS

FIG. 1 is a breakdown drawing of a compression device of a garbage can capable of compressing items contained in an internal space of the garbage can according to an embodiment of the invention;

FIG. 2 is composite structure diagram of a compression device of a garbage can capable of compressing items contained in an internal space of the garbage can according to an embodiment of the invention.

### DETAILED DESCRIPTION OF PREFERRED EMBODIMENTS

Appended drawing reference signs:
1—Transmission rod
2—Gear key
3—Driven rod
4—Bearing cap
5—Third gear
6—Fourth gear
7—Sensor mounting sheet
8—First gear
9—Second gear
10—First rotation rod
11—Second rotation rod
12—Reduction gearbox
13—Motor
14—Second fixing seat
15—First fixing seat
16—Fourth connecting rod
17—Third connecting rod
18—Second connecting rod
19—First connecting rod
20—First fixing rod
21—Second fixing rod
22—Pressure plate
23—First guide rod
24—Second guide rod

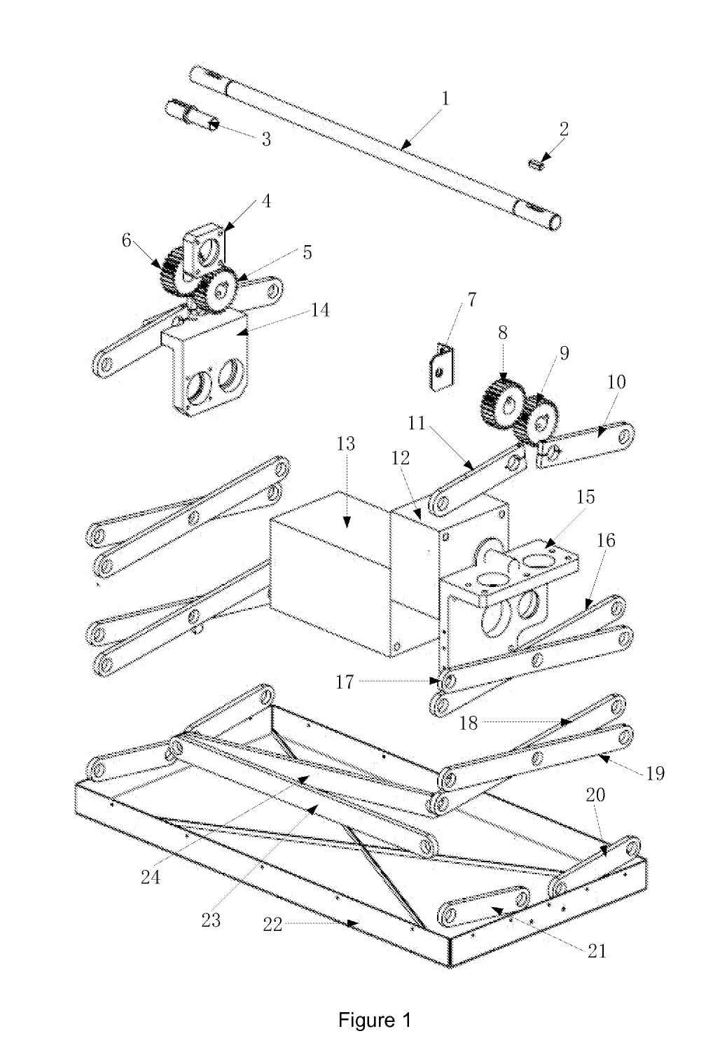

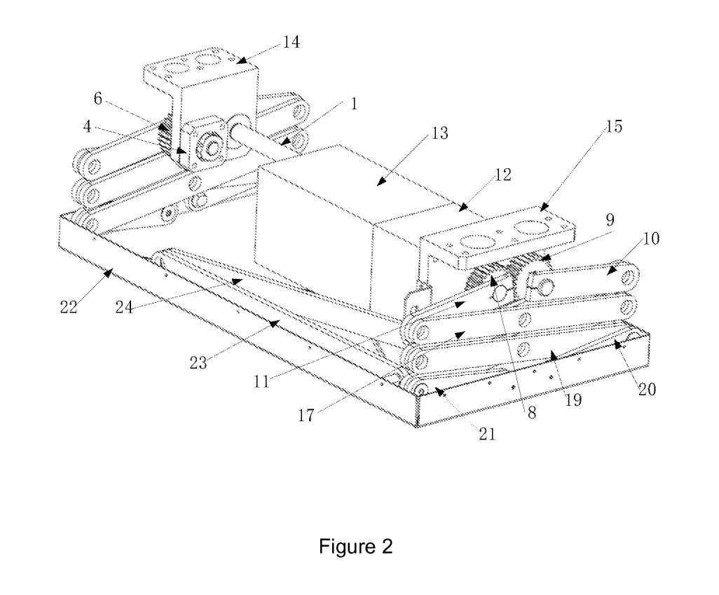

FIGS. 1 and 2 show a garbage can capable of compressing items contained in an internal space of the garbage can as provided by the invention. The garbage can comprises a can housing, wherein axially symmetrical openings are formed in a side wall at the upper end of the can housing; door sheets in fit sizes are arranged in the openings; the upper ends of the door sheets are articulated with the can housing; a compression device is arranged on the top surface in the can housing; a control end of the compression device is connected with an output end of a controller; an input end of the controller is connected with output ends of door opening sensing devices; the door opening sensing devices are arranged on the door sheets; and the controller compresses the items contained in the can housing to release the space according to door opening times detected by the door opening sensing devices. The garbage can is simple in structure, convenient and practical; the capacity of a waste bin is increased; after garbage in the garbage can or the waste bin is compressed, the single garbage can can store more garbage at a time; frequent replacement or cleaning is not required; the labor cost and garbage transportation cost are saved; and the garbage can is economical and practical.

The compression device comprises a pressure plate 22, a driving device, two telescopic brackets and a plurality of fixing shafts, wherein each of the two opposite ends of the pressure plate 22 is connected with one end of each telescopic bracket via the fixing shafts; and the other ends of the two telescopic brackets are connected with the driving device.

The compression device further comprises a first guide rod 23 and a second guide rod 24, wherein one end of the first guide rod 23 is connected with the second guide rod 24 via a connecting rod shaft; the other end of the first guide rod 23 is connected with the pressure plate 22 via a connecting rod shaft; and the other end of the second guide rod 24 is fixed on the driving device via a connecting rod shaft.

The driving device comprises a first fixing seat 15, a second fixing seat 14, a reduction gearbox 12, a motor 13, a gear, a transmission rod 1, a driven rod 3, a sensor mounting sheet 7 and a first sensor, wherein the gear comprises a first gear 8, a second gear 9, a third gear 5 and a fourth gear 6; the first fixing seat 15 and the second fixing seat 14 are oppositely arranged on a top plate in the can housing; two adjacent bearings are arranged on each of the first fixing seat 15 and the second fixing seat 14; the two ends of the transmission rod 1 penetrate through one bearing arranged on the first fixing seat 15 and one bearing arranged the second fixing seat 14 respectively, and the two bearings are arranged symmetrically; the second gear 9 and the third gear 5 are arranged at the two ends of the transmission rod and fixed by gear keys 2 respectively; a motor shaft of the motor 13 penetrates through the other bearing on the first fixing seat 15 via the reduction gearbox 12; the first gear 8 is arranged on the motor shaft and fixed by a gear key 2; the first gear 8 is engaged with the second gear 9; one end of the driven rod 3 is arranged on the other bearing on the second fixing seat 14; the fourth gear 6 is arranged at the other end of the driven rod 3 and fixed by a gear key 2; the third gear 5 is engaged with the fourth gear 6; the sensor mounting sheet 7 is arranged on a side wall of the first fixing seat 15; and the first sensor is arranged on the sensor mounting sheet 7.

The bearings on the first fixing seat 15 and the second fixing seat 14 are covered with bearing caps configured to prevent evaporation of oil on the bearings.

The telescopic brackets comprise first fixing rods 20, second fixing rods 21, first connecting rods 19, second connecting rods 18, third connecting rods 17, fourth connecting rods 16, first rotation rods 10, second rotation rods 11, a plurality of bearings and a plurality of connecting rod shafts, wherein one bearing is arranged at each of the two ends of each of the first fixing rods 20, the second fixing rods 21, the first connecting rods 19, the second connecting rods 18, the third connecting rods 17, the fourth connecting rods 16, the first rotation rods 10 and the second rotation rods 11; one bearing is arranged in the center of each of the first connecting rods 19, the second connecting rods 18, the third connecting rods 17 and the fourth connecting rods 16; the centers of the first connecting rods 19 and the second connecting rods 18 are connected by the connecting rod shafts; the centers of the third connecting rods 17 and the fourth connecting rods 16 are connected by the connecting rod shafts; one end of each first fixing rod 20 and one end of each second fixing rod 21 are connected with the pressure plate 22 via the connecting rod shafts; the other end of each first fixing rod 20 is connected with one end of each first connecting rod 19 via the connecting rod shaft; the other end of each first connecting rod 19 is connected with one end of each fourth connecting rod 16 via the connecting rod shaft; the other end of each fourth connecting rod 16 is connected with one end of each first rotation rod 10 via the connecting rod shaft; the other end of each first rotation rod 10 is connected with the transmission rod 1; the other end of each second fixing rod 21 is connected with one end of each second connecting rod 18 via the connecting rod shaft; the other end of each second connecting rod 18 is connected with one end of each third connecting rod 17 via the connecting rod shaft; the other end of each third connecting rod 17 is connected with one end of each second rotation rod 11 via the connecting rod shaft; and the other end of each second rotation rod 11 is connected with the motor shaft or the driven rod.

The door opening sensing devices comprise connecting rod fixing blocks, second connecting shafts, articulation connecting rods, first connecting rods, articulation bearings, slide shafts, slide fixing seats, linear bearings, second sensors and door opening sensing mounting sheets, wherein the connecting rod fixing rods are arranged on the door sheets; one end of each articulation connecting rod is fixed on each connecting rod fixing block via each second connecting shaft; each articulation bearing is arranged at the other end of each articulation connecting rod; one end of each slide shaft is fixed on each articulation bearing via each first connecting shaft; the other end of each slide shaft penetrates through each linear bearing and is arranged on each slide fixing seat; one end of each door opening sensing mounting sheet is arranged on each slide fixing seat; and each second sensor is arranged at the other end of each door opening sensing mounting sheet.

According to the garbage can, the door opening times of the door sheets on the can housing are detected by the sensors; when the times reach a certain value, the internal space is compressed once; after compression, the compression device will retract automatically; the use space in the compressed garbage can is enlarged reasonably; and when the sensors detect that the pressure plate returns to the original position, the compression device of the garbage can stops retraction.

The above mentioned is a merely better embodiment of the invention and is not used for limiting the invention; and any alteration, identical replacement, improvement and the like, within the spirit and principles of the invention, shall be included in the protection scope of the invention.

1. A garbage can capable of compressing items contained in an internal space thereof, wherein the garbage can comprises a can housing, axially symmetrical openings are formed in a side wall at the upper end of the can housing, door sheets in fit sizes are arranged in the openings, the upper ends of the door sheets are articulated with the can housing, a compression device is arranged on the top surface in the can housing, a control end of the compression device is connected with an output end of a controller, an input end of the controller is connected with output ends of door opening sensing devices, the door opening sensing devices are arranged on the door sheets, and the controller compresses the items contained in the can housing to release the space according to door opening times detected by the door opening sensing devices.

2. The garbage can of claim 1, wherein the compression device comprises a pressure plate, a driving device, two telescopic brackets and a plurality of fixing shafts; each of the two opposite ends of the pressure plate is connected with one end of each telescopic bracket via the fixing shafts; and the other ends of the two telescopic brackets are connected with the driving device.

3. The garbage can of claim 2, wherein the compression device further comprises a first guide rod and a second guide rod, one end of the first guide rod is connected with the second guide rod via a connecting rod shaft, the other end of the first guide rod is connected with the pressure plate via a connecting rod shaft, and the other end of the second guide rod is fixed on the driving device via a connecting rod shaft.

4. The garbage can of claim 3, wherein the driving device comprises a first fixing seat, a second fixing seat, a reduction gearbox, a motor, a gear, a transmission rod, a driven rod, a sensor mounting sheet and a first sensor; the gear comprises a first gear, a second gear, a third gear and a fourth gear; the first fixing seat and the second fixing seat are oppositely arranged on a top plate in the can housing; two adjacent bearings are arranged on each of the first fixing seat and the second fixing seat; the two ends of the transmission rod penetrate through one bearing arranged on the first fixing seat and one bearing arranged the second fixing seat respectively, and the two bearings are arranged symmetrically; the second gear and the third gear are arranged at the two ends of the transmission rod and fixed by gear keys respectively; a motor shaft of the motor penetrates through the other bearing on the first fixing seat via the reduction gearbox; the first gear is arranged on the motor shaft and fixed by a gear key; the first gear is engaged with the second gear; one end of the driven rod is arranged on the other bearing on the second fixing seat; the fourth gear is arranged at the other end of the driven rod and fixed by a gear key; the third gear is engaged with the fourth gear; the sensor mounting sheet is arranged on a side wall of the first fixing seat; and the first sensor is arranged on the sensor mounting sheet.

5. The garbage can of claim 4, wherein the telescopic brackets comprise first fixing rods, second fixing rods, first connecting rods, second connecting rods, third connecting rods, fourth connecting rods, first rotation rods, second rotation rods, a plurality of bearings and a plurality of connecting rod shafts; one bearing is arranged at each of the two ends of each of the first fixing rods, the second fixing rods, the first connecting rods, the second connecting rods, the third connecting rods, the fourth connecting rods, the first rotation rods and the second rotation rods; one bearing is arranged in the center of each of the first connecting rods, the second connecting rods, the third connecting rods and the fourth connecting rods; the centers of the first connecting rods and the second connecting rods are connected by the connecting rod shafts; the centers of the third connecting rods and the fourth connecting rods are connected by the connecting rod shafts; one end of each first fixing rod and one end of each second connecting rod are connected with the pressure plate via the connecting rod shafts; the other end of each first fixing rod is connected with one end of each first connecting rod via the connecting rod shaft; the other end of each first connecting rod is connected with one end of each fourth connecting rod via the connecting rod shaft; the other end of each fourth connecting rod is connected with one end of each first rotation rod via the connecting rod shaft; the other end of each first rotation rod is connected with the transmission rod; the other end of each second fixing rod is connected with one end of each second connecting rod via the connecting rod shaft; the other end of each second connecting rod is connected with one end of each third connecting rod via the connecting rod shaft; the other end of each third connecting rod is connected with one end of each second rotation rod via the connecting rod shaft; and the other end of each second rotation rod is connected with the motor shaft or the driven rod.

6. The garbage can of claim 1, wherein the door opening sensing devices comprise connecting rod fixing blocks, second connecting shafts, articulation connecting rods, first connecting rods, articulation bearings, slide shafts, slide fixing seats, linear bearings, second sensors and door opening sensing mounting sheets; the connecting rod fixing rods are arranged on the door sheets; one end of each articulation connecting rod is fixed on each connecting rod fixing block via each second connecting shaft; each articulation bearing is arranged at the other end of each articulation connecting rod; one end of each slide shaft is fixed on each articulation bearing via each first connecting shaft; the other end of each slide shaft penetrates through each linear bearing and is arranged on each slide fixing seat; one end of each door opening sensing mounting sheet is arranged on each slide fixing seat; and each second sensor is arranged at the other end of each door opening sensing mounting sheet.

7. The garbage can of claim 2, wherein the door opening sensing devices comprise connecting rod fixing blocks, second connecting shafts, articulation connecting rods, first connecting rods, articulation bearings, slide shafts, slide fixing seats, linear bearings, second sensors and door opening sensing mounting sheets; the connecting rod fixing rods are arranged on the door sheets; one end of each articulation connecting rod is fixed on each connecting rod fixing block via each second connecting shaft; each articulation bearing is arranged at the other end of each articulation connecting rod; one end of each slide shaft is fixed on each articulation bearing via each first connecting shaft; the other end of each slide shaft penetrates through each linear bearing and is arranged on each slide fixing seat; one end of each door opening sensing mounting sheet is arranged on each slide fixing seat; and each second sensor is arranged at the other end of each door opening sensing mounting sheet.

8. The garbage can of claim 3, wherein the door opening sensing devices comprise connecting rod fixing blocks, second connecting shafts, articulation connecting rods, first connecting rods, articulation bearings, slide shafts, slide fixing seats, linear bearings, second sensors and door opening sensing mounting sheets; the connecting rod fixing rods are arranged on the door sheets; one end of each articulation connecting rod is fixed on each connecting rod fixing block via each second connecting shaft; each articulation bearing is arranged at the other end of each articulation connecting rod; one end of each slide shaft is fixed on each articulation bearing via each first connecting shaft; the other end of each slide shaft penetrates through each linear bearing and is arranged on each slide fixing seat; one end of each door opening sensing mounting sheet is arranged on each slide fixing seat; and each second sensor is arranged at the other end of each door opening sensing mounting sheet.

9. The garbage can of claim 4, wherein the door opening sensing devices comprise connecting rod fixing blocks, second connecting shafts, articulation connecting rods, first connecting rods, articulation bearings, slide shafts, slide fixing seats, linear bearings, second sensors and door opening sensing mounting sheets; the connecting rod fixing rods are arranged on the door sheets; one end of each articulation connecting rod is fixed on each connecting rod fixing block via each second connecting shaft; each articulation bearing is arranged at the other end of each articulation connecting rod; one end of each slide shaft is fixed on each articulation bearing via each first connecting shaft; the other end of each slide shaft penetrates through each linear bearing and is arranged on each slide fixing seat; one end of each door opening sensing mounting sheet is arranged on each slide fixing seat; and each second sensor is arranged at the other end of each door opening sensing mounting sheet.

10. The garbage can of claim 5, wherein the door opening sensing devices comprise connecting rod fixing blocks, second connecting shafts, articulation connecting rods, first connecting rods, articulation bearings, slide shafts, slide fixing seats, linear bearings, second sensors and door opening sensing mounting sheets; the connecting rod fixing rods are arranged on the door sheets; one end of each articulation connecting rod is fixed on each connecting rod fixing block via each second connecting shaft; each articulation bearing is arranged at the other end of each articulation connecting rod; one end of each slide shaft is fixed on each articulation bearing via each first connecting shaft; the other end of each slide shaft penetrates through each linear bearing and is arranged on each slide fixing seat; one end of each door opening sensing mounting sheet is arranged on each slide fixing seat; and each second sensor is arranged at the other end of each door opening sensing mounting sheet.
